(19) United States
(12) Patent Application Publication
(10) Pub. No.: US 2001/0048087 A1
(43) Pub. Date: Dec. 6, 2001

(54) METHOD AND DEVICE FOR ACTIVATING AN ELECTROMAGNETIC CONSUMER

(76) Inventors: KLAUS ZIMMERMANN, KOENGEN (DE); MICHAEL STRAEHLE, MURR (DE); TOBIAS LANG, BENNINGEN (DE); BERND WICHERT, WAIBLINGEN (DE); KLAUS SASSEN, MARBACH/N (DE)

Correspondence Address: KENYON & KENYON, ONE BROADWAY, NEW YORK, NY, 10004, US

(21) Appl. No.: 09/432,338

(22) Filed: Nov. 2, 1999

(30) Foreign Application Priority Data
Nov. 25, 1998 (DE) 198 54 305.0

(51) Int. Cl. F16K 31/06

(52) U.S. Cl. 251/129.05

(57) ABSTRACT

A method and a device for activating an electromagnetic consumer having a movable element, in particular a solenoid valve for controlling the metering of fuel into an internal combustion engine. Within a time window, a switching instant at which the movable element reaches a certain position is determined. The duration of the time window can be defined so that the current flowing through the consumer during the time window does not exceed a threshold value.

### BACKGROUND INFORMATION

A method and a device for activating an electromagnetic consumer are known from German Patent No. 44 20 282. That patent describes a device for activating a consumer that includes a movable element. The consumer is a solenoid valve for controlling the metering of fuel into an internal combustion engine. Within a time window, a switching instant at which the movable element reaches a certain position is detected. This is accomplished by analyzing a time characteristic of a quantity corresponding to the current flowing through the consumer. During the time window when the current is being analyzed, the voltage applied to the consumer is regulated or controlled at a constant value.

In the cold start phase, the leads to the consumer have a low resistance, so the currents reach a higher level at a constant voltage than in normal operation. If current monitoring is provided to switch off the output stage after the current reaches a certain threshold value, this can lead to the output stage being disconnected by the current monitor.

This is problematical in particular when the consumer is connected to the power supply during the time window when the switching instant is detected. The current flowing through the consumer rises to different levels depending on the duration of the time window.

### SUMMARY OF THE INVENTION

An object of the present invention is to define a suitable duration of the time window within which the switching instant is detected with a method and a device for activating an electromagnetic consumer. The time window should be large enough for the switching instant to be detected. On the other hand, the time window should be so small that there is no current rise to inadmissible levels and thus the output stage is not disconnected.

Disconnection of the output stage current during detection of the switching instant is avoided through the procedure according to the present invention. The time window within which the switching instant is detected is defined in such a way that detection of the switching instant is possible, yet, the current does not rise to unacceptably high levels.

### BRIEF DESCRIPTION OF THE DRAWINGS

FIG. 1 shows a schematic diagram of the output stage.

FIG. 2a shows a first signal plotted over time.

FIG. 2b shows a second signal plotted over time.

FIG. 3 shows a flow chart to illustrate the procedure according to the present invention.

### DETAILED DESCRIPTION

The present invention is described below using the example of a consumer. The consumer is in particular a solenoid valve for controlling the metering of fuel into an internal combustion engine. The consumer includes a movable element which is usually called a valve needle in the case of a solenoid valve.

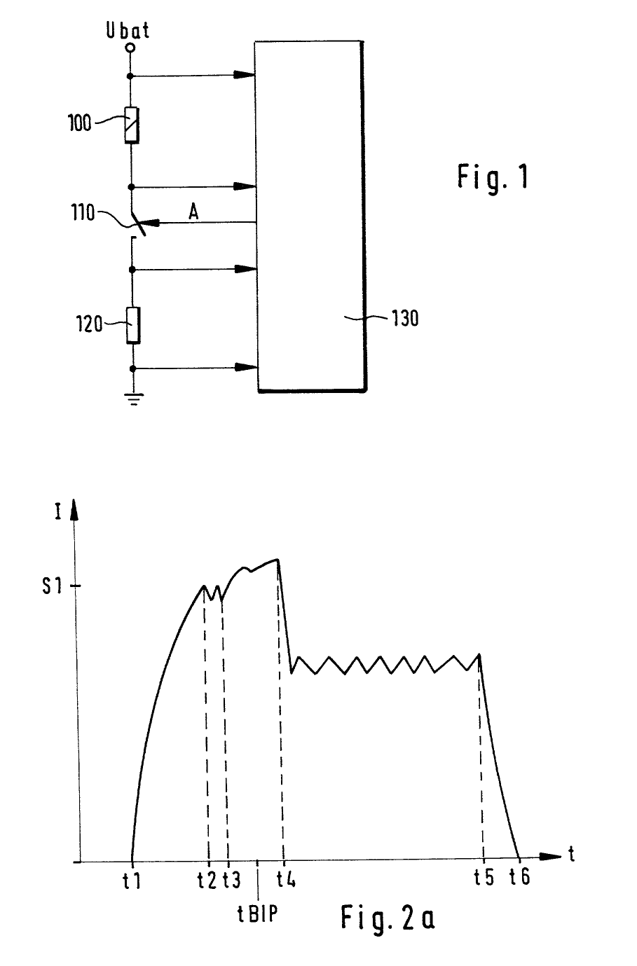

FIG. 1 illustrates the device according to the present invention on the basis of a block diagram. A first terminal of a consumer 100 is connected to a power supply Ubat, and the second terminal of consumer 100 is connected to the first terminal of switching means 110. The second terminal of switching means 110 is connected to the first terminal of a current measuring means 120. The second terminal of the current measuring means is connected to ground.

The terminals of consumer 100 and the terminals of current measuring means 120 send signals to a control unit 130, which in turn sends a control signal A to switching means 110.

In the embodiment illustrated here, consumer 100, switching means 110 and current measuring means 120 are connected in series in that order. This order is given only as an example. The three elements may also be arranged in another order. Thus, the switching means may also be arranged between the power supply voltage and the consumer. In addition, current measuring means 120 may be arranged between switching means 110 and consumer 100 or between consumer 100 and the power supply voltage. In addition, it is possible for additional switching means to be provided, in particular between consumer 100 and the power supply voltage.

Switching means 110 is implemented preferably in the form of a transistor, in particular a field effect transistor. Current measuring means 120 is preferably designed as an ohmic resistor. Consumer 100 is preferably the coil of a solenoid valve which is used to meter fuel.

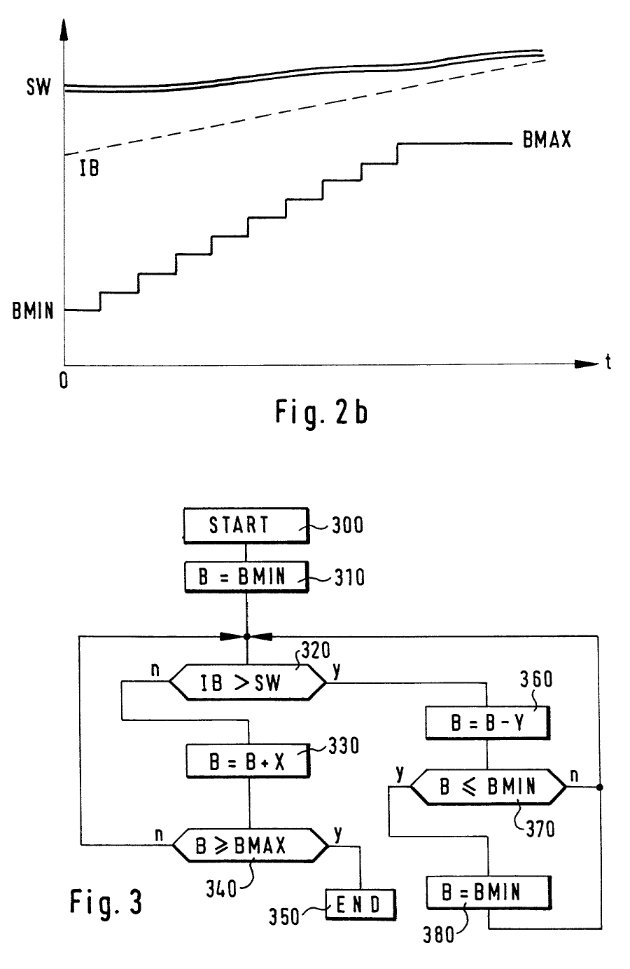

In FIG. 2a, current I flowing through consumer 100 and preferably through current measuring means 120 is detected and plotted over time. FIG. 2a illustrates metering or an injection process. Control of consumer 100 begins at time t1.

At this time t1, current I rises steeply. At time t2, a first value S1 is reached. At this time the switching means opens. If the current drops by a certain value, switching means 110 closes and the current rises again to value S1. Value S1 is also called the starting current.

The period of time between time t1 and time t2 is known as the free current ramp. Following this, the current is adjusted to the starting current.

A time window within which switching means 110 is constantly in a closed state begins at time t3. This results in a current rise. The movable element reaches its new end position at time tBIP because of the magnetic force. This results in a change in the consumer's inductance, which then causes a change in the current rise. The time window ends at time t4.

After time t4, the current is regulated at a second value S2. This value is also known as the holding current. Control of the consumer ends at time t5, when switching means 110 is opened and the current drops to 0 by time t6.

The current variation is shown only schematically and may also assume different forms with other types of solenoid valves or other control methods. In particular the curve shape while reaching the new end position at time tBIP may be different. It is important that the current characteristic has a break and/or a discontinuity at switching instant tBIP. This break is usually detected by current analysis.

One problem now is that switching means 110 is closed constantly during time t3 to t4. Therefore, the current rises very steeply in this period of time with a low ohmic resistance of consumer 100. This can lead to the maximum allowed current value being exceeded and the output stage being disconnected, i.e., switching means 110 is permanently open.

Times t3 and t4 define a time window within which the switching instant is detected. Switching means 110 is in its closed state within the time window. Switching instant tBIP is detected by analysis of the current curve within the time window. During the time window, which is defined by times t3 and t4, consumer 100 receives power supply voltage Ubat and the time curve of the current is analyzed to determine the switching time. Due to the fact that the consumer receives the power supply voltage in the time window, control in the time window is greatly simplified and no voltage control is necessary.

The limits for time window t3 and t4 are preferably defined on the basis of switching instant tBIP of the preceding control and width B of the time window. The calculation is preferably performed according to the equation:

t3=tBIP−B/2

t4=tBIP+B/2

Width B of the time window is defined as shown in FIG. 3.

The current rise during the time window is limited according to the present invention by the definition of the time window, i.e., the interval between times t3 and t4. This takes place in particular on startup of the internal combustion engine.

FIG. 2b shows the duration of the time window plotted against time with a solid line. Maximum value IB of current I, which is detected just before time t4, is plotted with a broken line. In addition, threshold value SW is plotted with a double line. The relationships in normal undisturbed operation are shown.

At time 0, i.e., when starting up the internal combustion engine, a minimal value BMIN for the duration of the time window is defined, i.e., in the interval between t3 and t4. Maximum value IB of the current is definitely below threshold value SW. Consequently, by a larger value is defined for the time window at the next injection. This means that duration B of the time window increases several steps over time until reaching a maximum value BMAX. The BMIN value is selected so that even under unfavorable conditions, maximum current IB is no greater than threshold value SW.

Maximum value IB of the current increases simultaneously with the increase in duration B of the time window. However, the maximum value does not reach threshold value SW. Threshold value SW is selected so that it is slightly less than the maximum allowed current value at which the current monitor responds.

FIG. 2b also shows that threshold value SW is not constant but instead it is defined as a function of battery voltage Ubat received by the consumer. As shown in FIG. 2b, this value increases slowly during the startup operation.

FIG. 3 illustrates the procedure according to the present invention on the basis of a flow chart. The procedure according to the present invention is preferably performed only once after starting the internal combustion engine. This means that the program begins at step 300 after starting the internal combustion engine.

In the next step 310, value B for the time window is set at minimum value BMIN. Subsequent query 320 determines whether the maximum value of current IB is greater than threshold value SW. If this is not the case, i.e., maximum value IB of the current is lower than threshold value SW, then time window B is increased by value X in step 330.

Maximum value IB of the current corresponds to the current intensity prevailing at time at t4. If it is difficult or impossible to detect this with the measurement technology, a current intensity immediately before time t4 may also be used as maximum value IB. Maximum value IB of the current corresponds to the greatest current intensity measured in the time window. Maximum value IB of current I is preferably determined immediately before the end of the time window (t4).

Subsequent query 340 determines whether width B of the time window is greater than maximum value BMAX. If this is the case, the program ends at step 350.

If this is not the case, query 320 is performed again. In normal operation, program steps 320, 330 and 340 are run through several times until width B of the time window has reached maximum value BMAX. If this is the case, the procedure is terminated.

If query 320 detects that maximum value IB of the current is greater than threshold value SW, then width B of the window is reduced by value Y in step 360. Subsequent query 370 determines whether width B is less than or equal to minimum value BMIN. If this is not the case, query 320 is performed again. If this is the case, width B is set at minimum value BMIN in step 380, and query 320 is performed again.

This means that if maximum value IB of the current is greater than threshold value SW, width B of the window is reduced by value Y until maximum value IB of the current is lower than the threshold value. Measures are preferably taken to prevent the value from dropping below minimum value BMIN.

According to the present invention, the duration of the time window is increased starting from a starting value (BMIN) if the current is lower than the threshold value. The duration of the time window is increased until reaching a maximum value (BMAX) for the duration. The duration of the time window is reduced if the current is greater than the threshold value.

What is claimed is:

1. A method of activating an electromagnetic consumer having a movable element, the electromagnetic consumer including a solenoid valve for controlling a metering of fuel into an internal combustion engine, comprising the steps of:
determining a duration of a time window such that a current flowing through the consumer during the time window does not exceed a threshold value; and
determining a switching instant at which the movable element has reached a particular position within the time window.

2. The method according to claim 1, further comprising the step of increasing the duration of the time window starting from a starting value if the current is lower than the threshold value.

3. The method according to claim 1, further comprising the step of reducing the duration of the time window if the current is greater than the threshold value.

4. The method according to claim 1, further comprising the step of increasing the duration of the time window until reaching a maximum value for the duration.

5. The method according to claim 1, further comprising the steps of:
receiving a power supply voltage at the consumer during a period of time; and
analyzing a time variation of the current to determine the switching instant.

6. The method according to claim 1, further comprising the step of determining the current immediately before an end of the time window.

7. A device for activating an electromagnetic consumer having a movable element, the electromagnetic consumer including a solenoid valve for controlling a metering of fuel into an internal combustion engine, the device comprising:
means for determining a duration of a time window such that a current flowing through the consumer during the time window does not exceed a threshold value; and
means for determining a switching instant at which the movable element has reached a particular position within the time window.
